(19) United States
(12) Patent Application Publication
(10) Pub. No.: US 2013/0202438 A1
(43) Pub. Date: Aug. 8, 2013

(54) KINETIC ENERGY MULTIPLIER ROTARY ENGINE

(71) Applicant: Jesus Carrillo Galvan, Monterrey (MX)

(72) Inventor: Jesus Carrillo Galvan, Monterrey (MX)

(21) Appl. No.: 13/447,754

(22) Filed: Apr. 16, 2012

(30) Foreign Application Priority Data
Feb. 3, 2012 (MX) MX/A/2012/001511

(51) Int. Cl. F01D 15/00; F01D 25/16; F03G 7/10

(52) U.S. Cl. 416/170 R; 416/174; 415/916

(57) ABSTRACT

A kinetic energy multiplier rotary engine which operates by increasing the multiplied force of kinetic energy, which starts thanks to its accelerator and the rotary movement of its different sized masses that the kinetic energy rotary engine has in its structure. The purpose of this invention is to provide energy so that moving and/or electrical energy equipment will operate to provide a more practical, cleaner, less costly and less pollutant energy than the types of energy existing today, since the latter are costly and highly pollutant. This purpose is accomplished thanks to a simple innovative construction whose main characteristic consists of masses and magnets that provide rotary movement on the engine shaft.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a kinetic energy multiplier rotary engine. More particularly, the present invention relates to a kinetic energy multiplier rotary engine which is used to run machinery, vehicles, electrical household appliances and electric power generators, with energy obtained cleanly and simply. Consequently, the engine performs this function at a low cost and thus contributes to improving the environment in terms of pollution.

2. Description of Related Art Including Information Disclosed Under 37 CFR 1.97 and 37 CFR 1.98.

Engines for vehicles, just like for machinery and electric power generators are driven by petroleum derivatives, all of them highly pollutant, and their manufacturing and maintenance cost is high, compared to this kinetic energy multiplier rotary engine introduced. The kinetic energy multiplier rotary engine does not require any petroleum derivative for operating and its components are low cost.

The difference is that new invention devices that generate kinetic energy, of one single magnitude, do not multiply such energy. The reason that their use is not generalized is perhaps because they are not efficient and this makes them costly with regard to manufacture and operation. In contrast to that, this new and useful kinetic energy multiplier rotary engine multiplies kinetic energy by using masses with different sizes that move each other and that can be manufactured with different materials.

### BRIEF SUMMARY OF THE INVENTION

This invention covers a kinetic energy multiplier rotary engine, which operates by increasing the multiplied force of kinetic energy, which starts thanks to its accelerator and the rotary movement of its different sized masses that the kinetic energy rotary engine has in its structure.

The purpose of this invention is to provide energy so that moving and/or electrical energy equipment will operate to provide a more practical, cleaner, less costly and less pollutant energy than the types of energy existing today, since the latter are costly and highly pollutant. This purpose is accomplished thanks to a simple innovative construction whose main characteristic comprises of masses and magnets that provide rotary movement on the engine shaft.

### BRIEF DESCRIPTION OF THE SEVERAL VIEWS OF THE DRAWINGS

FIG. 1 shows an elevation view of the kinetic energy multiplier rotary engine.

FIG. 2 shows a side view without the tubular box.

FIG. 3 shows a front view of the impeller.

FIG. 4 shows a front view of the magnetic accelerator.

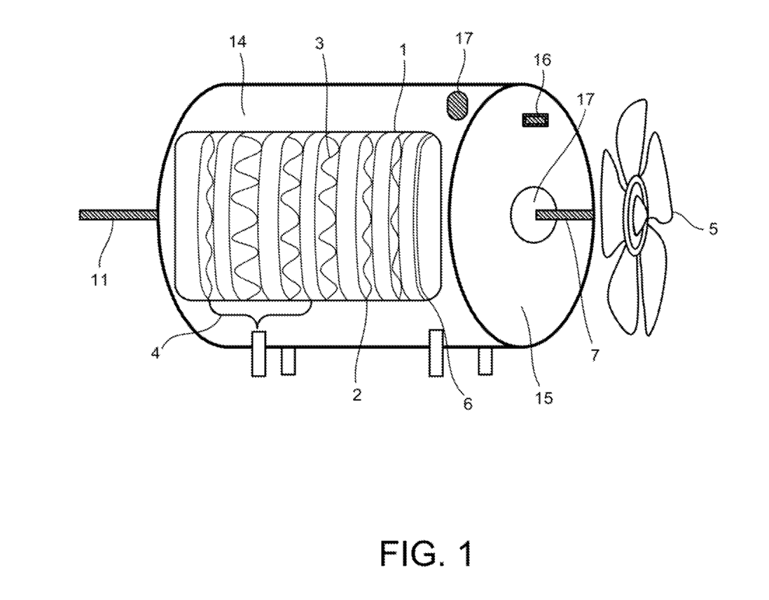

### DETAILED DESCRIPTION OF THE INVENTION

The way in which this very useful invention will develop is shown below together with drawings showing it. The component masses are also shown.

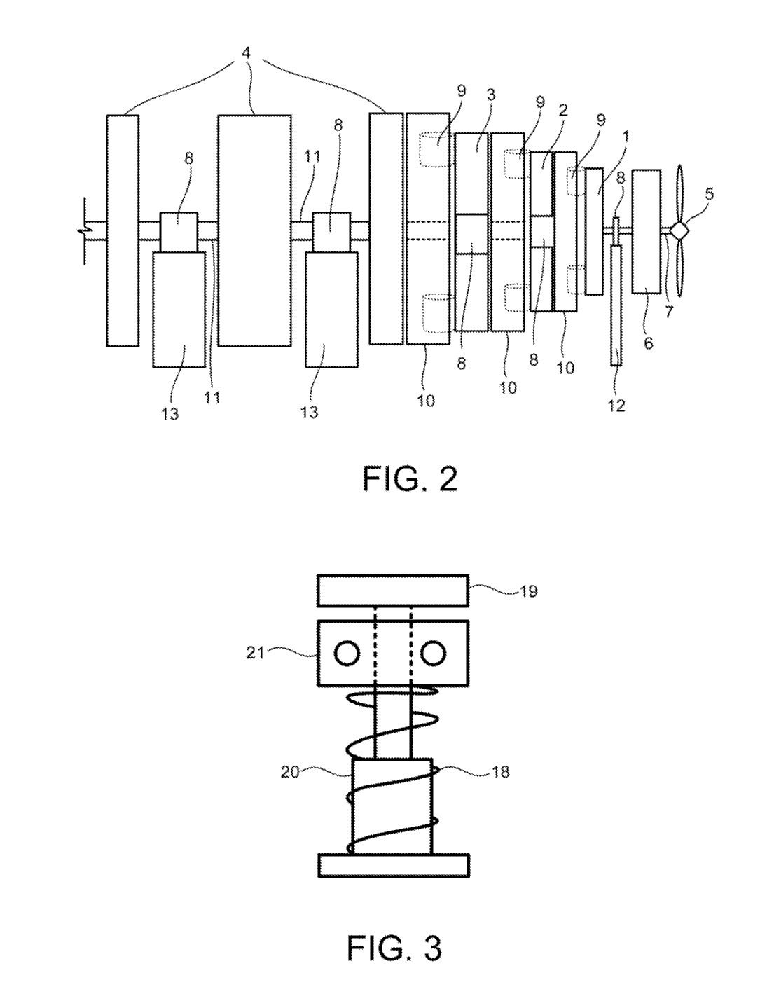

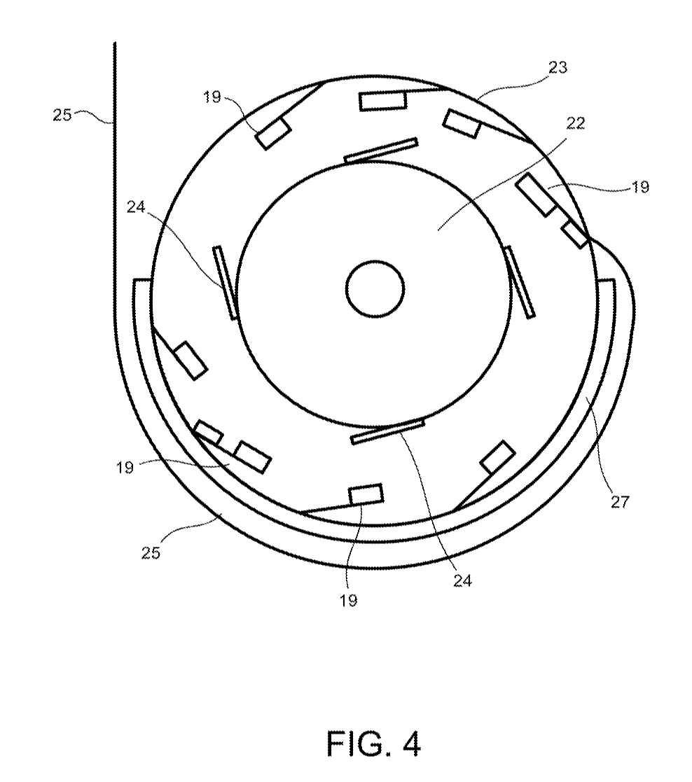

In reference to FIG. 2, the kinetic energy multiplier rotary engine consists primarily of two shafts (7, 11) of which shaft (7) is mounted on the bearing (8) and the latter, in turn, is set on a support. (12). A mass (1) is placed on one of the ends of this shaft (7) on which 4 impellers (9) are installed on one of its faces. This is formed according to FIG. 3, of the following magnet pieces (19), rod (20), compression spring (18) and base (21), on the other end vanes are installed (5) and on the same shaft (7) next to them we install the magnetic accelerator (6), which comprises the following masses according to FIG. 4: a disk-shaped piece (22), aluminum ring (23), steel plates (24), 6 fixed magnets (19), 2 displacement magnets (19), cable (25) and accelerator support (27). The following shaft (11) is installed on two bearings (8) and these are mounted on two supports (13). On this shaft (11), the masses (2,3) are installed with their respective impellers (9), rings (10) and bearings (8). However, we first mounted the mass (4) fixed with its respective ring (10), we split it to balance the weight of the masses (1, 2 ,3) on the shaft (11), so that the rings (10) of these masses cover the impellers (9), of each contiguous mass, including the mass (1), all of this is installed in a tubular box (14), on the cover of the tubular box (15), the retainer (17) is installed, and a valve (16) to make vacuum.

To begin, we used the magnetic accelerator, FIG. 4, driving the magnets (19) to a position so that they will be in front of the steel plates (24) and are attracted to them, causing the disk (22) to rotate and the latter, in turn, rotates the shaft (11). Thus the mass (1) starts rotating. And, as a result of the centrifugal force that it has when it rotates, the rod (20) and the magnet (19) move toward the ring (10) of the mass (2) without actually touching it and, by the force of its magnetic field the magnet (19) drives the ring (10) in the direction of the mass (1). Likewise, this mass (2) causes the mass (3) to rotate, and the latter causes mass (4) to rotate, thanks to the attraction of the magnet (19), all the masses are rotating as if they were only one, with everything and shafts (7, 11), as if they were only one piece that weighs one hundred twenty-five times more than the initial mass. With the first one being preferably 1 Kg, the second one preferably 5 Kg, the third one preferably 25 Kg. Consequently, the fourth one would be preferably 125 Kg, following the same proportion.

As the applied force of the magnetic accelerator (6) multiplies, so does the applied force of the vanes or that of the battery-operated electric motor multiplies. All three forces operate in combination with one another. Vanes rotate with the wind coming from a vehicle as it moves. As the force applied to the shaft (7) ceases, the mass (1) loses speed in its rotary movement and with this, centrifugal force is lost, causing the impeller (9) to return to its original location due to the spring separating it from the ring, and the other masses (2, 3,4) do so successively.

In practice we experimented with three masses, the first one weighing 1 Kg, the second one 5 Kg, and the third one 25 Kg. Consequently the fourth one would be 125 Kg following the same proportion. It should be mentioned that masses can be manufactured preferably of machined steel, cast steel and concrete can be used in engines of large dimensions.

1. Kinetic energy multiplier rotary engine, characterized by two shafts of which a first shaft is mounted on a bearing and the a second of said shafts, in turn is mounted on a support; to said first shaft on one of its ends a mass is installed to which preferably four impellers are installed on one of its faces.

2. Kinetic energy multiplier rotary engine of claim 1, characterized by impellers comprising of magnet pieces, rod, compression spring and base; vanes are installed on the other end and, on the same first shaft next to them the magnetic accelerator is installed, which comprises of one disk-shaped piece, an aluminum ring, steel plates, six fixed magnets, two displacement magnets, a cable and an accelerator support, the second shaft is mounted on two bearings and two supports are mounted on these; on this second shaft the masses are mounted with their respective impellers, rings and bearings, but we first mount the mass fixed, with its respective ring; we split it to balance the weight of the masses on the shaft, so that the rings of these masses will cover the impellers, of each contiguous mass, including the first mass, all of this is installed in a tubular box; the retainer and a valve are installed on the tubular box cover to make a vacuum.

3. Kinetic energy multiplier rotary engine of claim 1, characterized because for its operation, the magnetic accelerator is used driving the magnets to a position so that they will be in front of the steel plates and are attracted to them causing the disk to rotate and the latter will, in turn, rotate the second shaft so that the first mass starts rotating and as a result of its centrifugal force when it rotates; the rod and magnet move toward the ring of the second mass without actually touching it and, by the force of its magnetic field, the magnet drives the ring in the direction of the first mass, in the same way this second mass causes the third mass to rotate and the latter causes the fourth mass to do the same due to the attraction of the magnet, all the masses are rotating as if they were one single mass, with everything and shafts, as a single mass that weighs one hundred twenty-five times more than the initial mass, with the first one being preferably 1 Kg, the second one preferably 5 Kg. the third one preferably 25 Kg; consequently, the fourth one would be preferably 125 Kg., following the same proportion.

4. Kinetic energy multiplier rotary engine of claim 1, characterized by the fact that as the applied force of the magnetic accelerator is applied, the force of the vanes of the battery-operated electric motor is applied; the three combined forces also operate with one another, the vanes rotate with the wind coming from a vehicle as it moves; when the force applied to the first shaft ceases, the first mass loses speed as it rotates and with this centrifugal force is lost, causing the impeller to return to its original location due to the spring separating from the ring, and the other masses do so successively.

5. Kinetic energy multiplier rotary engine of claim 1, characterized by the fact that it can start its rotary movement with the magnetic accelerator, alone or in combination with the vanes or the electric motor.

6. Kinetic energy multiplier rotary engine of claim 1, characterized by the fact that multiplication is performed based on masses of different sizes.

7. Kinetic energy multiplier rotary engine of claim 2, characterized by the fact that it uses magnetic fields for driving masses of different sizes.

8. Kinetic energy multiplier rotary engine of claim 2, characterized by the fact that it uses magnetic fields to drive masses of different sizes.

9. Kinetic energy multiplier rotary engine of claim 1, characterized by the fact that the masses operate under a vacuum, which avoids air friction on its masses

10. Kinetic energy multiplier rotary engine of claim 1, characterized by the fact that it can be integrated into one multiple unit.

11. Kinetic energy multiplier rotary engine of claim 1, characterized by the fact that it can operate at low and high revolutions per minute because the bearings have a wide range of more than 10,000 rpm.

12. Kinetic energy multiplier rotary engine of claim 1, characterized by the fact that it uses centrifugal force to run the impellers.
